(19) United States
(12) Patent Application Publication
(10) Pub. No.: US 2009/0000587 A1
(43) Pub. Date: Jan. 1, 2009

(54) SOUND QUALITY CONTROL APPARATUS FOR INTERNAL COMBUSTION ENGINE

(75) Inventors: Naohito SEKO, Kariya-city (JP); Toshiaki NAKAYAMA, Nishikamo-gun (JP); Yoshitaka NISHIO, Nagoya-city (JP); Seiji TACHIBANA, Toyoake-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/134,793

(22) Filed: Jun. 6, 2008

(30) Foreign Application Priority Data
Jun. 27, 2007 (JP) 2007-169336

(51) Int. Cl. F02M 35/10

(52) U.S. Cl. 123/184.57; 123/198 E

(57) ABSTRACT

A sound quality control apparatus includes an air intake duct defining a suction passage, through which air is supplied to an engine, and having a double tube part, and an air cleaner that filters the air flowing through the suction passage. The double tube part includes an outer pipe and an inner pipe disposed in the outer pipe. The inner pipe defines a communicating passage communicating with the suction passage. The outer pipe and the inner pipe define a resonant chamber therebetween. The outer pipe has a branch opening part that opens in a vehicle interior of an automobile, or a branch opening part that opens toward a vicinity of the vehicle interior of the automobile. The inner pipe has a thin film partition wall that divides the resonant chamber airtightly from the communicating passage.

### CROSS REFERENCE TO RELATED APPLICATION

This application is based on and incorporates herein by reference Japanese Patent Application No. 2007-169336 filed on Jun. 27, 2007.

### BACKGROUND OF THE INVENTION

1. Field of the Invention

The present invention relates to a sound quality control apparatus for an internal combustion engine that is installed in a vehicle such as an automobile.

2. Description of Related Art

### (Conventional Art)

Conventionally, as shown in FIG. 4, a sound quality control apparatus for an internal combustion engine is publicly known. The sound quality control apparatus includes an air intake duct 101 and a resonator 102 disposed on the air intake duct 101. The air intake duct 101 connects a downstream side (clean side) of a filter element of an air cleaner in an intake air flow direction and a throttle body receiving a throttle valve which controls an amount of suction air into the engine (see e.g., JP2005-139982A corresponding to US2007/0131189A1). The resonator 102 includes a resonance body 103, a volume chamber 104, and a neck portion 106. The resonance body 103 is vibrated by a suction pulse of the engine. The volume chamber 104 is connected to the air intake duct 101 through the resonance body 103. An internal space 105 in the volume chamber 104 communicates with the outside through the neck portion 106.

The neck portion 106 of the resonator 102 is located near a dash panel 107, and is disposed such that an opening of the neck portion 106 is opposed to a dash panel 107. The neck portion 106 is configured such that its cross section is reduced with respect to the volume chamber 104 in order to generate Helmholtz resonance based on vibration of the resonance body 103. Accordingly, sound pressure properties of a suction noise caused by the suction pulse of the engine include a sound pressure of a sound emitted from the resonator 102. Thus, the sound pressure properties of the suction noise are tuned to desired properties using the resonator 102.

Moreover, another sound quality control apparatus for the engine is conventionally proposed. The sound quality control apparatus includes a first outside air introduction duct connected to an upstream side (dust side) of a filter element of an air cleaner in an intake air flow direction, and a second outside air introduction duct branching from the first outside air introduction duct so as to open on a dash panel side. According to the sound quality control apparatus, sound quality in a passenger compartment is improved by leaking a suction noise from the first outside air introduction duct into the second outside air introduction duct, and then adjusting a duct length of the second outside air introduction duct branching from the first outside air introduction duct, the suction noise conducted into the second outside air introduction duct is made to resonate in the second outside air introduction duct (see e.g., JP2006-083787A corresponding to US2007/0131189A1).

(Problems with the Conventional Art)

However, in the sound quality control apparatus for the engine described in JP2005-139982A, when a suction noise in a low frequency band is taken out, the volume chamber 104 of the resonator 102 becomes large, and thereby an installation space for the resonator 102 becomes large within an engine compartment of a vehicle. In some types of vehicles, the air intake duct 101 may not be disposed near the dash panel or a side panel. In such a case, volume of the neck portion 106, volume of the volume chamber 104, and mass of the resonance body 103 are difficult to adjust in setting a frequency band of the sound pressure of the sound emitted from the resonator 102 at a sound pressure in a desired frequency band.

In the sound quality control apparatus for the engine described in JP2006-083787A, a resonance is determined by the duct length of the second outside air introduction duct, In some vehicles, desired duct length is not achieved due to an installation space in an engine compartment for the apparatus, and thereby the duct length is difficult to adjust. Furthermore, air flows into and out of the second outside air introduction duct, and the second outside air introduction duct is connectable only with the dust side of the air cleaner. Accordingly, there is a low degree of flexibility in installation arrangement of the first and second outside air introduction ducts.

### SUMMARY OF THE INVENTION

The present invention addresses the above disadvantages. Thus, it is an objective of the present invention to provide a sound quality control apparatus for an internal combustion engine. An installation space for the sound quality control apparatus in an automobile is small, so that insatiability of the sound quality control apparatus in the automobile is improved Moreover, the sound quality control apparatus is easily tuned up to obtain a suction noise having a desired frequency. In addition, the sound quality control apparatus has a higher degree of flexibility in its installation arrangement in the automobile.

To achieve the objective of the present invention, there is provided a sound quality control apparatus for an internal combustion engine installed in an automobile. The sound quality control apparatus includes an air intake duct and an air cleaner. The air intake duct defines a suction passage, through which air is supplied to the engine, and has a double tube part. The air cleaner is configured to filter the air flowing through the suction passage. The double tube part includes an outer pipe and an inner pipe, which is disposed in the outer pipe. The inner pipe defines a communicating passage. The outer pipe and the inner pipe define a resonant chamber therebetween. The communicating passage communicates with the suction passage. The outer pipe has one of a branch opening part that opens in a vehicle interior of the automobile, and a branch opening part that opens toward a vicinity of the vehicle interior of the automobile. The inner pipe has a thin film partition wall that divides the resonant chamber airtightly from the communicating passage.

### BRIEF DESCRIPTION OF THE DRAWINGS

The invention, together with additional objectives, features and advantages thereof, will be best understood from the following description, the appended claims and the accompanying drawings in which:

FIG. 1 is a schematic view illustrating an intake air control system for an internal combustion engine according to a first embodiment of the invention;

FIG. 2A is a longitudinal sectional view illustrating a major portion of an air intake duct according to the first embodiment;

FIG. 2B is a cross-sectional view taken along a line 11B-11B in FIG. 2A according to the first embodiment;

FIG. 3 is a schematic view illustrating an intake air control system for an internal combustion engine according to a second embodiment of the invention; and

FIG. 4 is a schematic view illustrating a major portion of a previously proposed intake air control system for an internal combustion engine.

### DETAILED DESCRIPTION OF THE INVENTION

The following embodiments of the invention achieve a purpose of making small a installation space for a double tube part in an automobile to improve installability of the double tube part in the automobile, and easily tuning up a suction noise having a desired frequency that is taken out from a resonant chamber and a branch opening part in the double tube part of an air intake duct by providing a thin film partition wall (cylindrical thin film resonance body or cylindrical thin film suction noise permeation body) to the double tube part. The cylindrical thin film resonance body divides the resonant chamber airtightly from a communicating passage, and resonates with the suction noise in the air intake duct, thereby being vibrated. The suction noise having the desired frequency permeates the cylindrical thin film suction noise permeation body.

### First Embodiment

### Configuration of the First Embodiment

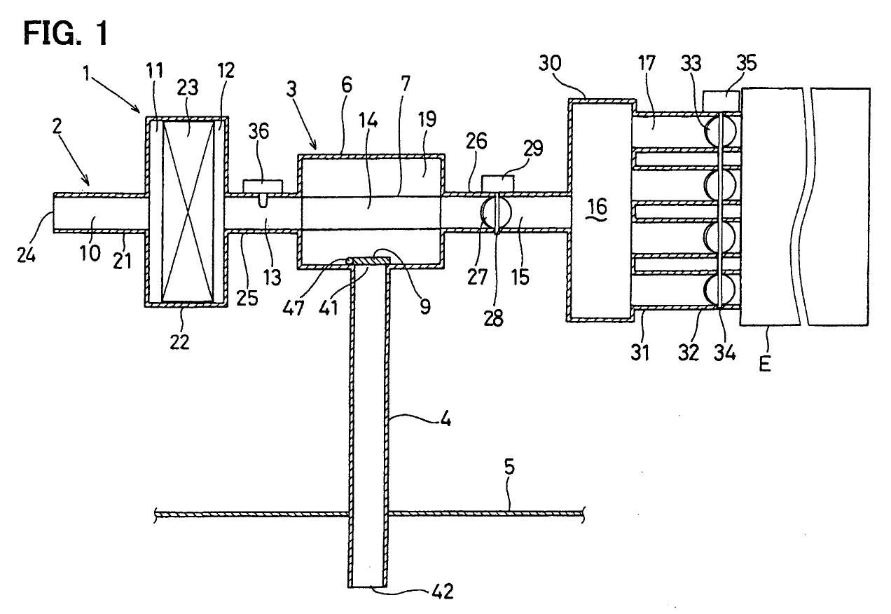

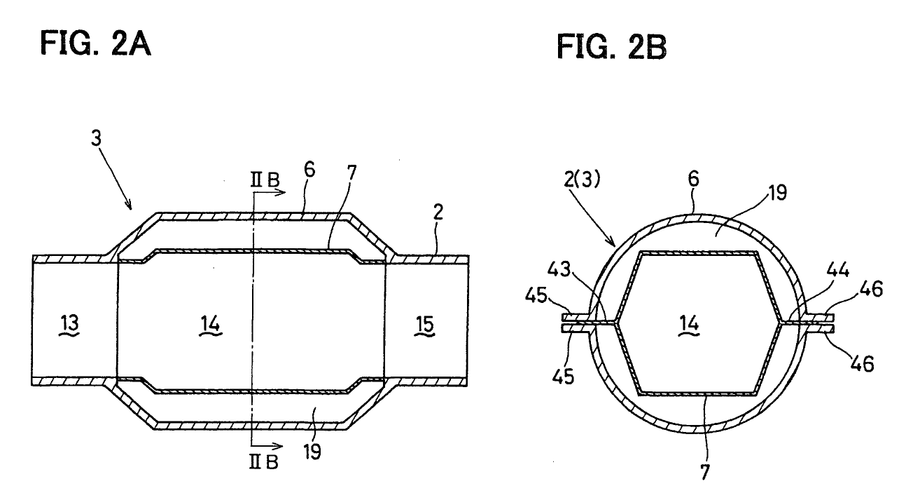

FIGS. 1 to 2B show a first embodiment of the invention. FIG. 1 shows an intake air control system for an internal combustion engine.

A control unit (engine control system) of the internal combustion engine according to the first embodiment is used as an intake air control system for the internal combustion engine having a suction passage opening/closing device (intake air amount control device for the internal combustion engine) that opens and closes suction passages (an outside air introduction passage 10, a suction passage 13, a communicating passage 14, a suction passage 15, and a branch suction passage 17) for supplying intake air to a combustion chamber in each cylinder of an internal combustion engine (e.g., four-cylinder gasoline engine: hereinafter referred to as an engine) E installed in an engine compartment of an automobile, an intake swirl generator that generates an intake air swirling current to promote combustion of an fuel/air mixture in the combustion chamber in each cylinder of the engine E, and a sound quality control apparatus (sound quality control apparatus of the internal combustion engine) that controls sound quality of a suction noise generated caused by an engine suction pulse. The intake air control system having the sound quality control apparatus is incorporated into an engine inlet system, and is installed in the engine compartment.

The engine E generates output power using heat energy obtained by combusting fuel/air mixture of clean intake air filtered through an air cleaner (air cleaner of the internal combustion engine) 1 and fuel injected by an injector in the combustion chamber. A four-stroke engine which repeats four strokes, that is, an intake stroke, a compression stroke, an expansion (combustion) stroke, and an exhaust stroke, as its period (cycle) is used for the engine E. The engine E includes an air intake duct (an intake duct or an intake pipe) 2 for supplying intake air into the combustion chamber in each cylinder, and an exhaust duct (exhaust pipe) for discharging exhaust gas flowing out of the combustion chamber in each cylinder of the engine E into the outside via an exhaust emission control system.

The engine E includes a cylinder head and a cylinder block. Inlet ports formed on one side of the cylinder head are opened and closed by a poppet intake valve, and exhaust ports formed on the other side of the cylinder head are opened and closed by a poppet exhaust valve. A piston connected with a crankshaft via a connecting rod is slidably held in its sliding direction in a cylinder bore formed in the cylinder block. A spark plug is attached to the cylinder head of the engine E so that its end portion is exposed to the inside of the combustion chamber in each cylinder. Furthermore, an injector (electromagnetic fuel injection valve), which injects fuel into the inlet port with optimal timing, is attached to the cylinder head.

The air cleaner 1 includes an outside air introduction duct (inlet duct of the air cleaner) 21 installed in an uppermost stream part of the air intake duct 2 of the engine E, an air cleaner case 22 connected to the downstream end of the outside air introduction duct 21, and an air cleaner element (filter element) 23 received and held in an internal space (a dust side space 11 and a clean side space 12) of the air cleaner case 22. The filter element 23 filters intake air (outside air) conducted into the internal space in the air cleaner case 22 from an outside air introduction port (admission port of the air intake duct 2) 24, which opens at an upstream end of the outside air introduction duct 21. More specifically, the filter element 23 is a barrier filter (air filter) which prevents engine sliding wear or the like due to the suction of hard impure substance into the combustion chamber of the engine E by capturing and removing impure substances (dust such as dirt or sand) in outside air conducted from the outside air introduction port 24. In addition, an intake pipe 25 is connected to the downstream end of the air cleaner case 22.

The suction passage opening/closing device of the first embodiment includes a throttle body 26 disposed along the air intake duct (intake pipe of the internal combustion engine) 2 of the engine E, that is, on a downstream side of the air cleaner 1 in a flow direction (intake air flow direction) of intake air, a throttle valve 27 received in the inside (suction passage 15) of the throttle body 26 for opening and closing the suction passage 15, and a return spring (or a default spring) which urges the throttle valve 27 in a valve closing operation direction (or a valve opening operation direction).

The throttle body 26 has an actuator (electric motor 29), which drives the throttle valve 27 in the valve opening operation direction (or the valve closing operation direction) through a shaft 28. The throttle valve 27 is an intake volume control valve, which variably controls a flow (amount of suction air) of intake air which flows through the suction passage 15 according to a throttle opening degree corresponding to its valve opening degree. The electric motor 29 is configured to be driven (energization of the electric motor 29 is controlled) by an engine control unit (hereinafter referred to as an ECU).

The intake swirl generator of the first embodiment includes intake air flow control valves (tumble flow control valve: hereinafter referred to as TCV) which generate the intake air vortical flow (tumble flow) in a longitudinal direction in the combustion chamber in each cylinder of the engine. The TCV includes each branch duct part (housing) 32 of an intake manifold 31 disposed at a most downstream part of the air intake duct 2 of the engine E, that is, on a downstream side of a surge tank 30 in the intake air flow direction, an intake air flow control valve 33 received in the inside (branch suction passage 17) of the housing 32 to open and close the branch suction passage 17, and a return spring which urges the intake air flow control valve 33 in a valve opening operation direction (or a valve closing operation direction).

The intake manifold 31 has an actuator (electric motor 35) which drives the intake air flow control valve 33 in a valve closing operation direction (or a valve opening operation direction) through a shaft 34. The intake air flow control valve 33 is a tumble flow control valve, which generates a tumble flow in the combustion chamber in each cylinder of the engine E by reducing a passage cross-sectional area of the branch suction passage 17 when the branch suction passage 17 is fully closed or half-open. The electric motor 35 is configured to be driven (energization of the electric motor 35 is controlled) by the ECU.

The ECU has a microcomputer having a widely known configuration. The microcomputer includes functions of, for example, a central processing unit (CPU) which performs control processing and arithmetic processing, a storage unit (memory such as a read-only memory (ROM) or random access memory (RAM)) which saves a control program or control logic and various data, an input circuit (input part), an output circuit (outputting part), a power supply circuit, and a timer. The ECU is configured to control the energizations of the electric motors 29, 35 based on the control program or control logic stored in the memory when an ignition switch is turned on (IG-ON). Accordingly, the amount of suction air (throttle opening degree), the valve opening degree of the TCV, and the like are controlled to have respective control command values (control target values) when the engine E is in operation. The ECU is configured such that engine control (air/fuel ratio control, ignition control, and fuel injection control as well) including throttle opening control and valve opening degree control of the TCV based on the control program or control logic stored in the memory is forcibly terminated when the ignition switch is turned off (IG-OFF).

The air intake duct 2 of the engine E is a casing which defines the suction passage for supplying intake air to the combustion chamber in each cylinder of the engine E. The air intake duct 2 includes the air cleaner case 22 having the outside air introduction duct 21, the intake pipe 25 joined to a downstream side of the air cleaner case 22 in the intake air flow direction, a double tube part 3 joined to a downstream side of the intake pipe 25 in the intake air flow direction, the throttle body 26 joined to a downstream side of the double tube part 3 in the intake air flow direction, the surge tank 30 joined to a downstream side of the throttle body 26 in the intake air flow direction, and the intake manifold 31 joined to a downstream side of the surge tank 30 in the intake air flow direction.

The outside air introduction passage 10, which communicates with the internal space in the air cleaner case 22, is formed inside the outside air introduction duct 21. The suction passage 13, which communicates with the inside (communicating passage 14) of the double tube part 3, is formed inside the intake pipe 25. The suction passage (throttle bore) 15, which communicates with the internal space (expansion chamber) 16 of the surge tank 30, is formed inside the throttle body 26. The cylinder head of the engine E is airtightly joined to a downstream end of each housing 32 of the intake manifold 31. An air flow meter 36, which converts the amount of suction air supplied into the combustion chamber in each cylinder (all the cylinders) of the engine E into an electrical signal and outputs the signal to the ECU, is provided on the air intake duct 2 of the engine E, or on the intake pipe 25 in particular.

The sound quality control apparatus of the first embodiment includes the air cleaner 1, the air intake duct 2 which conducts intake air into the combustion chamber in each cylinder of the engine E, and a branch duct 4 branching from the double tube part (branched portion) 3 of the air intake duct 2 and extending toward the inside of the passenger compartment of the automobile. The branch duct 4 is a casing extending straightly in a front-back direction of the automobile from a branch opening part 41 formed in the double tube part 3 to an opening 42 which opens in the passenger compartment of the automobile. Alternatively, the branch duct 4 may be a casing extending straightly in the front-back direction of the automobile from the branch opening part 41 to an opening which opens near a dash panel 5 (or side panel) of the automobile. In the first embodiment, the open end side (one end side) of the branch duct 4 penetrates through the dash panel 5 which divides the engine compartment from the passenger compartment of the automobile.

The air intake duct 2 of the first embodiment includes the suction passage (especially the outside air introduction passage 10, the suction passage 13, the communicating passage 14, the suction passage 15, and the branch suction passage 17) for supplying intake air into the combustion chamber in each cylinder of the engine E, and the double tube part 3 partly formed along the suction passage. The double tube part 3 of the air intake duct 2 is disposed on a downstream side (clean side) of the filter element 23 of the air cleaner 1 in the intake air flow direction. The intake pipe 25 and the throttle body 26 are airtightly connected through the double tube part 3, which includes a cylindrical outer pipe 6, an inner pipe (thin film partition wall 7) having a rectangular pipe shape, and a switch valve 9. The outer pipe 6 is formed from resin materials (e.g., polypropylene (PP) and polyamide resin (PA)) having higher rigidity than the thin film partition wall 7. The outer pipe 6 is formed integrally with the air intake duct 2 along the air intake duct 2, and has a cylindrical resonant chamber (expansion chamber) 19 formed between the outer pipe 6 and the thin film partition wall 7. The branch opening part 41, which opens toward the inside of the passenger compartment (or toward the vicinity to the passenger compartment) of the automobile, is formed on a part of the outer pipe 6 in its circumferential direction.

The inner pipe is disposed in the outer pipe 6, and is formed from the thin film partition wall (film like a thin membrane) 7, which airtightly divides the inner communicating passage 14 from the outer resonant chamber 19. The thin film partition wall 7 is a multangular tubed pellicular resin body (e.g., PEN film like a thin membrane) formed from resin materials (e.g., polyethylene terephthalate (PET), PP, polyethylene-2,6-naphthalate (PEN)) having higher flexibility than the outer pipe 6. Alternatively, the thin film partition wall 7 may be a multangular tubed thin film metal body formed from metallic materials (e.g., aluminium or iron) having higher flexibility than the outer pipe 6. Or, the thin film partition wall 7 may be a multangular tubed thin film elastic body formed from elastic materials (e.g., rubber) having higher flexibility than the outer pipe 6.

The thin film partition wall 7 defines the communicating passage 14 that communicates with the combustion chamber in each cylinder of the engine E. The communicating passage 14 serves as a relay suction passage (relay route) that communicates between the inside (suction passage 13) of the intake pipe 25 and the suction passage 15. The thin film partition wall 7 is disposed to surround the communicating passage 14 in its circumferential direction, and projections 43, 44 project from an outer circumferential surface of the thin film partition wall 7, and extend along a direction (intake air flow direction) in which the communicating passage 14 is defined. The projections 43, 44 are placed and fixed between opposed parts 45, 46 of the outer pipe 6, respectively. Accordingly, the thin film partition wall 7 is received in the outer pipe 6 with its circumference surrounded by the resonant chamber 19.

The thin film partition wall 7 serves as a cylindrical thin film resonance body which resonates with a suction noise propagating through the inside of the air intake duct 2, and is thereby vibrated. The thin film partition wall 7 also serves as a cylindrical suction noise permeation body, through which the suction noise having a desired frequency permeates from a communicating passage 14-side toward a resonant chamber 19-side. The resonant chamber 19 of the double tube part 3 is formed such that the suction noise having a desired frequency, which has permeated the thin film partition wall 7, is emitted through the branch opening part 41 toward the inside of the passenger compartment (or toward the vicinity to the passenger compartment) of the automobile. A switch valve 9 is a valve body which opens and closes the branch opening part 41 formed in the outer pipe 6 of the double tube part 3. A shaft 47 of the switch valve 9 is rotatably pivotal-supported by the outer pipe 6. The volume of (sound pressure level) of the suction noise may be tuned up according to the valve opening degree of the switch valve 9. Also, the switch valve 9 may be fully closed to reduce (or isolate) the suction noise propagating in the passenger compartment of the automobile.

### Workings of the First Embodiment

Workings of the intake air control system of the internal combustion engine according to the first embodiment, or workings of the sound quality control apparatus in particular, are briefly described below with reference to FIGS. 1 to 2B.

When the ignition switch is turned on (IG-ON), outside air is drawn through the outside air introduction port 24 of the air cleaner 1 according to the throttle opening degree of the throttle valve 27, and thereby the engine E is started up. Meanwhile, when a specific cylinder of the engine E makes the transition from the exhaust stroke to the intake stroke, in which the intake valve opens and the piston descends, negative pressure (pressure lower than an atmospheric pressure) in the combustion chamber of the cylinder becomes higher as the piston descends, and thereby a fuel/air mixture is suctioned into the combustion chamber through the inlet port which is open. The engine E repeats four strokes, that is, the intake stroke, the compression stroke, the expansion stroke, and the exhaust stroke, by turns by carrying out the opening/closing operation of the intake valve and the ascent/descent motion of the piston. Consequently, vibration of intake air, or the suction pulse is generated across the whole inside of the air intake duct 2. A suction pulse sound, that is, the suction noise propagates through the inside of the air intake duct 2 due to the suction pulse.

When the suction noise, which has propagated through the inside of the air intake duct 2, reaches the double tube part 3 from an engine E-side, the thin film partition wall (cylindrical thin film resonance body) 7 used as the inner pipe of the double tube part 3 resonates with (a specific frequency band including) a desired (specific) frequency of the suction noise which has propagated through the inside of the air intake duct 2, so that the thin film partition wall 7 is vibrated. By adjusting a shape, thickness, area, or position of the thin film partition wall 7, the suction noise having (the specific frequency band (e.g., about 100-400 Hz) including) the desired frequency, for example, a suction noise that is comfortable for a driver, permeates the thin film partition wall 7. Then, the suction noise propagates from the resonant chamber 19 and the branch opening part 41 of the double tube part 3 through the inside of the branch duct 4, which penetrates through the dash panel 5. After that, the suction noise is emitted to the passenger compartment of the automobile from the opening 42 of the branch duct 4.

The resonant chamber 19 is formed such that the suction noise having (a desired frequency band including) a desired frequency, which has permeated the thin film partition wall (cylindrical thin film suction noise permeation body) 7, propagates to the inside of the branch duct 4 through the branch opening part 41, and then is emitted to the passenger compartment of the automobile from the opening 42 of the branch duct 4. Accordingly, the suction noise having the desired frequency, which is emitted from the resonant chamber 19 and the branch opening part 41, propagates efficiently to the inside of the passenger compartment of the automobile. By emitting the suction noise having the desired frequency, which is taken out from the resonant chamber 19 and the branch opening part 41, toward the passenger compartment of the automobile, the sound quality of the suction noise that is emitted (that propagates) to the passenger compartment of the automobile is improved.

As a result, even in a case where the air intake duct 2 for conducting intake air into the combustion chamber of each cylinder of the engine E is not installed near the dash panel 5 which divide the engine compartment from the passenger compartment of the automobile, the permeating sound is easily tuned up by adjusting the shape, thickness, area, or position of the thin film partition wall 7. Therefore, since the suction noise having the desired frequency is take out from the resonant chamber 19 and the branch opening part 41, the sound quality of the suction noise emitted to the passenger compartment of the automobile is improved.

The thin film partition wall 7 is employed as the inner pipe of the double tube part 3 of the air intake duct 2. Accordingly, since the suction noise having the desired frequency penetrates through the thin film partition wall 7, the suction noise emitted to the engine compartment (or atmosphere) through the outside air introduction port (admission port of the air intake duct 2) 24, which opens at the upstream end of the outside air introduction duct 21 of the air cleaner 1, becomes small. Consequently, the silencing effect of reducing the suction noise emitted through the outside air introduction port 24 is expectably produced. Thus, both effects of reducing the suction noise and improving the sound quality of the suction noise are expectably produced.

### Advantageous Effects of the First Embodiment

As mentioned above, in the sound quality control apparatus of the first embodiment, the double tube part 3 that includes the outer pipe 6 defining therein the resonant chamber 19 and the thin film partition wall 7 defining therein the communicating passage 14 is disposed between the intake pipe 25, which is placed along the air intake duct 2 of the engine E or on the downstream side of the filter element 23 of the air cleaner 1 in the intake air flow direction in particular, and the throttle body 26, which receives the throttle valve 27 such that the throttle valve 27 is opened or closed. The thin film partition wall (the cylindrical thin film resonance body or the cylindrical thin film suction noise permeation body) 7 is employed as the inner pipe of the double tube part 3 of the air intake duct 2. The above thin film partition wall 7 divides the communicating passage 14 airtightly from the resonant chamber 19. The thin film partition wall 7 resonates with the desired frequency of the suction noise propagating through the inside of the air intake duct 2 and is vibrated. Moreover, the suction noise having the desired frequency permeates the thin film partition wall 7 from the communicating passage 14-side toward the resonant chamber 19-side of the thin film partition wall 7.

The resonant chamber 19 is formed such that the suction noise having the desired frequency, which has permeated the thin film partition wall 7, propagates to the inside of the branch duct 4 through the branch opening part 41, and then is emitted to the passenger compartment of the automobile from the opening 42 of the branch duct 4. Accordingly, since the suction noise having the desired frequency is take out from the resonant chamber 19 and the branch opening part 41 directly to the passenger compartment of the automobile, the sound quality of the suction noise emitted to the passenger compartment of the automobile is improved. Furthermore, the branch duct 4 extending from the branch opening part 41 to the opening 42 which opens in the passenger compartment of the automobile is formed on the outer pipe 6 of the double tube part 3. Accordingly, the suction noise having the desired frequency is directly taken out into the passenger compartment of the automobile. Thus, a degree of flexibility in installation arrangement of the air intake duct 2 and the branch duct 4 becomes high without depending on the duct length of the branch duct 4.

The tuning of the suction noise (extracted sound) having the desired frequency taken out directly from the resonant chamber 19 and the branch opening part 41 is performed by tuning (varying) the shape, thickness, area, or position of the thin film partition wall 7. More specifically, the tuning may be performed by changing the shape of the thin film partition wall 7 from a hexagonal shape into an octagonal shape, or by changing the area of the thin film partition wall 7 through the insertion of a rib in planes of the thin film partition wall 7. By making large the area of the thin film partition wall 7 in particular, the thin film partition wall 7 resonates with the suction noise of a low frequency band, and as a result, the suction noise of the above low frequency band is taken out. Thus, the tuning of the extracted sound is easily performed without depending on the duct length of the branch duct 4.

In particular, when a suction noise (e.g., a suction noise having a low frequency around 100 Hz) in a low frequency band is taken out from the resonant chamber 19 and the branch opening part 41, the suction noise in the low frequency band is taken out from the resonant chamber 19 and the branch opening part 41 only by tuning up the shape, thickness, area, or position of the thin film partition wall 7, without making large the volume of the resonant chamber 19. Consequently, upsizing of the resonant chamber 19 is restricted, and thereby an installation space in the engine compartment of the automobile for the double tube part 3 is made small. Thus, the installation of the resonant chamber 19 in the engine compartment of the automobile is improved.

The suction noise having the desired frequency permeates through the thin film partition wall 7 from the communicating passage 14-side toward the resonant chamber 19-side of the thin film partition wall 7. As a result, the suction noise having the desired frequency is taken out from the resonant chamber 19 and the branch opening part 41. The tuning of the suction noise (permeating sound) having the desired frequency that permeates the thin film partition wall 7 is performed by tuning up the shape, thickness, area, or position of the thin film partition wall 7. In addition, by making thin thickness of the thin film partition wall 7, the suction noise permeating the thin film partition wall 7 is made large. As a result, a louder suction noise is taken out. Thus, the tuning of the permeating sound is easily performed.

The thin film partition wall 7 integrated into the double tube part 3 of the air intake duct 2 divides the communicating passage 14, which communicates with the combustion chamber in each cylinder of the engine E, airtightly from the resonant chamber 19 connected to the branch duct 4 which opens in the passenger compartment of the automobile, Accordingly, even if air enters through the opening 42 from the passenger compartment of the automobile into the branch duct 4, and the air enters further into the resonant chamber 19 through the branch opening part 41, the air does not permeate the thin film partition wall 7. In other words, the air does not flow into the communicating passage 14 in the thin film partition wall 7 from the branch opening part 41, and the air does not flow out of the communicating passage 14 to the branch opening part 41, either. Thus, even when the double tube part 3 is installed on the upstream side (dust side) of the filter element 23 of the air cleaner 1 in the intake air flow direction, foreign objects, for example, dust such as dirt or sand, or water included in the air which has entered into the resonant chamber 19 through the branch opening part 41, are not suctioned into the communicating passage 14. Hence, the foreign objects are not suctioned into the combustion chamber in each cylinder of the engine E, and thereby engine sliding wear, or the like, is prevented. As a result, the double tube part 3 may be disposed both on the upstream side and on the downstream side (clean side) of the filter element 23 in the intake air flow direction.

### Second Embodiment

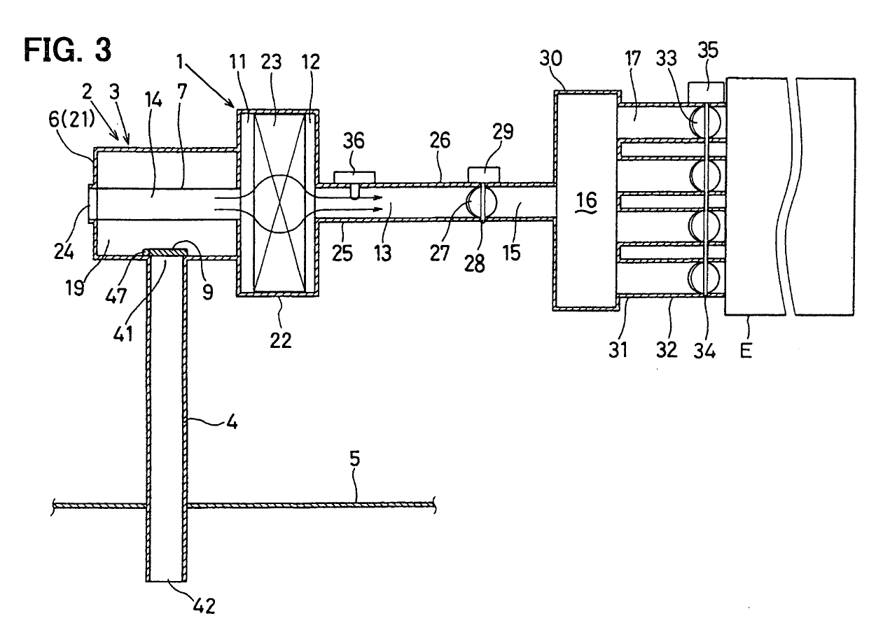

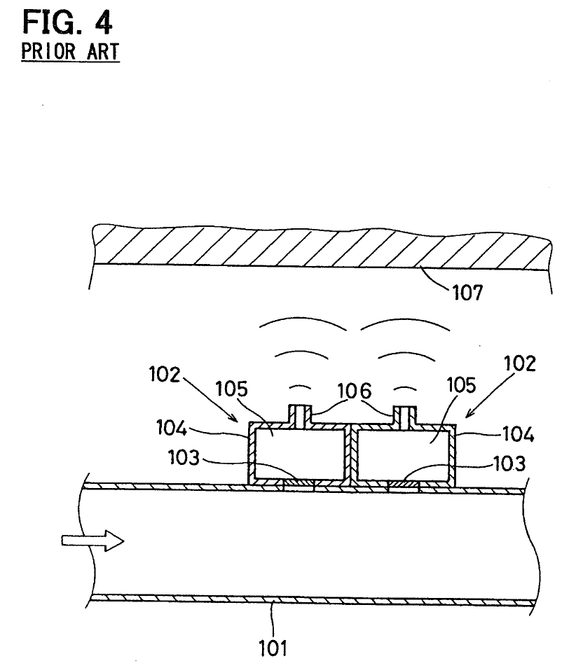

FIG. 3 shows a second embodiment of the invention. FIG. 3 illustrates an intake air control system for the internal combustion engine having a sound quality control apparatus.

In the sound quality control apparatus of the second embodiment, a double tube part 3 of an air intake duct 2, or a thin film partition wall 7, in particular, is disposed on an upstream side (dust side) of a filter element 23 of an air cleaner 1 in an intake air flow direction. More specifically, the double tube part 3 is formed integrally with an outside air introduction duct 21 and an air cleaner case 22 of the air cleaner 1. An outer pipe 6 of the double tube part 3 serves as the outside air introduction duct 21. A branch duct 4 extends from the outside air introduction duct 21 toward the inside of the passenger compartment of the automobile (or toward the vicinity to the passenger compartment). A resonant chamber 19 defined by the thin film partition wall 7 and the outside air introduction duct 21 is formed such that the suction noise having a desired frequency, which has permeated the thin film partition wall 7, is emitted through a branch opening part 41 toward the inside of the passenger compartment (or toward the vicinity to the passenger compartment) of the automobile. A communicating passage 14 defined by the thin film partition wall 7 communicates between an outside air introduction port (admission port of the air intake duct 2) 24 which opens at an upstream end of the outside air introduction duct 21 and an internal space (dust side space 11 in particular) of the air cleaner case 22. As mentioned above, in the sound quality control apparatus of the second embodiment, similar effects to the first embodiment are achieved.

### (Modifications)

In the above embodiments, the suction passage opening/closing device and the intake swirl generator are disposed in the air intake duct 2 of the engine E. However, It is not necessary to dispose the suction passage opening/closing device or the intake swirl generator in the air intake duct 2 of the engine E as long as at least the sound quality control apparatus (sound quality improvement apparatus) is disposed in the air intake duct 2. In the above embodiments, the branch duct 4, which extends from the branch opening part 41 of the outer pipe 6 of the double tube part 3 to the opening 42 that opens in the passenger compartment of the automobile, penetrating through the dash panel 5 (or side panel), is connected to the outer pipe 6. Alternatively, a branch duct extending from the branch opening part 41 of the outer pipe 6 to an opening, which opens near the dash panel 5 or the side panel (i.e., inside the engine compartment) may be connected to the outer pipe 6. Moreover, it is not necessary to dispose the branch duct, and a neck-shaped branch portion may be disposed to surround the circumference of the branch opening part 41. In addition, two or more branch opening parts 41 may be formed on the outer pipe 6. In this case, two or more branch ducts 4 are also installed in accordance with the branch opening parts 41. The whole inner pipe, or a part of the inner pipe may be formed into a cylindrical thin film partition wall. Also, the thin film partition walls may be disposed at intervals of a predetermined distance in a circumferential direction of the inner pipe.

Additional advantages and modifications will readily occur to those skilled in the art. The invention in its broader terms is therefore not limited to the specific details, representative apparatus, and illustrative examples shown and described.

What is claimed is:

1. A sound quality control apparatus for an internal combustion engine installed in an automobile, comprising:
an air intake duct that defines a suction passage, through which air is supplied to the engine, and that has a double tube part; and
an air cleaner configured to filter the air flowing through the suction passage, wherein:
the double tube part includes an outer pipe and an inner pipe, which is disposed in the outer pipe;
the inner pipe defines a communicating passage;
the outer pipe and the inner pipe define a resonant chamber therebetween;
the communicating passage communicates with the suction passage;
the outer pipe has one of:
a branch opening part that opens in a vehicle interior of the automobile; and
a branch opening part that opens toward a vicinity of the vehicle interior of the automobile; and
the inner pipe has a thin film partition wall that divides the resonant chamber airtightly from the communicating passage.

2. The sound quality control apparatus according to claim 1, wherein the thin film partition wall is disposed to surround the communicating passage.

3. The sound quality control apparatus according to claim 1, wherein the thin film partition wall resonates with a specific frequency of a suction noise of the air flowing in the air intake duct and thereby vibrates.

4. The sound quality control apparatus according to claim 1, wherein the thin film partition wall is a suction noise permeation body, which a suction noise having a specific frequency permeates from the communicating passage toward the resonant chamber.

5. The sound quality control apparatus according to claim 4, wherein the resonant chamber is formed such that the suction noise having the specific frequency, which permeates the suction noise permeation body to the resonant chamber, is emitted to one of the vehicle interior of the automobile and the vicinity of the vehicle interior of the automobile through the branch opening part.

6. The sound quality control apparatus according to claim 1, wherein the double tube part has a branch duct extending from the branch opening part to an opening that opens in one of the vehicle interior of the automobile and the vicinity of the vehicle interior of the automobile.

7. The sound quality control apparatus according to claim 1, wherein the double tube part has a branch duct extending from the branch opening part to an opening that opens in a vicinity of one of a dash panel and a side panel of the automobile.

8. The sound quality control apparatus according to claim 1, wherein the double tube part has a valve that opens and closes the branch opening part.

9. The sound quality control apparatus according to claim 1, wherein the double tube part is disposed on an upstream side of an element of the air cleaner in a flow direction of the air suctioned into the engine.

10. The sound quality control apparatus according to claim 1, wherein the double tube part is disposed on a downstream side of an element of the air cleaner in a flow direction of the air suctioned into the engine.
